(19) United States
(12) Patent Application Publication
(10) Pub. No.: US 2013/0208233 A1
(43) Pub. Date: Aug. 15, 2013

(54) THREE DIMENSIONAL GLASSES

(71) Applicant: TSUNG-CHIN WANG, Tu-Cheng (TW)

(72) Inventor: TSUNG-CHIN WANG, Tu-Cheng (TW)

(21) Appl. No.: 13/653,430

(22) Filed: Oct. 17, 2012

(30) Foreign Application Priority Data
Feb. 15, 2012 (TW) 101104857

(51) Int. Cl. G02C 11/00

(52) U.S. Cl. 351/158

(57) ABSTRACT

A pair of three dimensional glasses comprising a frame, a pair of lenses, and a control unit is disclosed. The frame includes a front casing and a rear casing engaged to the front casing. The front casing, and the rear casing are combined to define right and left rims for receiving the lenses and an interior space positioned at the middle of the frame for receiving the control unit. The control unit has a circuit board, a battery, and an infrared device. The battery and the infrared device are mounted and electrically connected to the circuit board. The control unit is positioned in the middle of the frame, and therefore the 3D glasses of the disclosure uses less electrical parts and has a lighter construction.

### BACKGROUND

1. Technical Field

The disclosure is related to a pair of three dimensional (3D) glasses, and particularly to a pair of 3D glasses of light weight.

2. Description of Related Art

Watching movies in 3D has become popular. 3D technology relies on the viewer wearing a set of 3D glasses. There are two categories of 3D glasses, passive and active. Passive 3D glasses used filters to perform 3D stereoscopic image effects. Each filter passes only that light which is similarly polarized and blocks the light polarized in the opposite direction; therefore, each eye of viewers sees a different image. This is used to produce a 3D effect by projecting the same scene into both eyes, but depicted from slightly different perspectives. Active 3D glasses operate independently to perform 3D stereoscopic image effects, such as, dual-display 3D glasses or liquid crystal shutter (LCS) 3D glasses, for example. The LCS 3D glasses alternatively dim the right and then the left lenses in succession so that each of the user's eyes sees a slightly different angle of the same image to create 3D stereoscopic effect.

Active 3D glasses are driven by electricity to provide power and related signals for switching the lenses. The electrical devices to control the shutters are constructed on the temple arms close to the frame of the 3D glasses. Current active 3D glasses are bulky, and the weight of the electrical device is applied to user's ears, which can make users uncomfortable when wearing the current 3D glasses. A flexible circuit board is needed for receiving signals from the electrical devices and coupling to the outside edges of the lenses (near the temple arms of 3D glasses). The flexible circuit board has to extend the electrical connection from the outside edge of one lens to the outside edge of another lens. The electrically connected structure of the active 3D glasses of related art requires a larger and more intrusive flexible circuit board. The extension part of the flexible circuit is fragile and easily torn during transportation or assembly. Therefore, it is desired to provide a pair of 3D glasses which can overcome the above-described limitations.

### BRIEF DESCRIPTION OF THE DRAWINGS

The components in the drawings are not necessarily drawn to scale, the emphasis instead being placed upon clearly illustrating the principles of a pair of 3D glasses. Moreover, in the drawings, like reference numerals designate corresponding parts throughout the several views.

FIG. 1 is an exploded view of a pair of 3D glasses of the disclosure.

FIG. 2 is enlarged view of the 3D glasses illustrating a control unit positioned between a pair of lenses of the 3D glasses.

FIG. 3 is a schematic diagram illustrating the assembly of lenses and a circuit board.

### DETAILED DESCRIPTION

The disclosure will described with references to the accompanying diagrams.

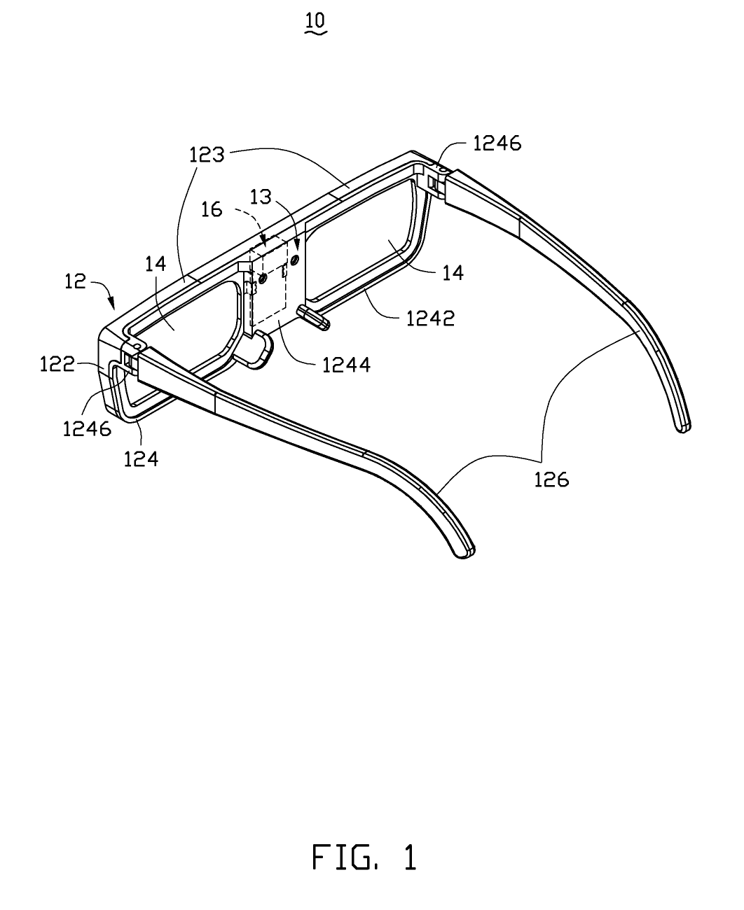

FIG. 1 shows a schematic diagram of a pair of 3D glasses 10 of the disclosure. The 3D glasses 10 include a frame 12, a pair of lenses 14, and a control unit 16.

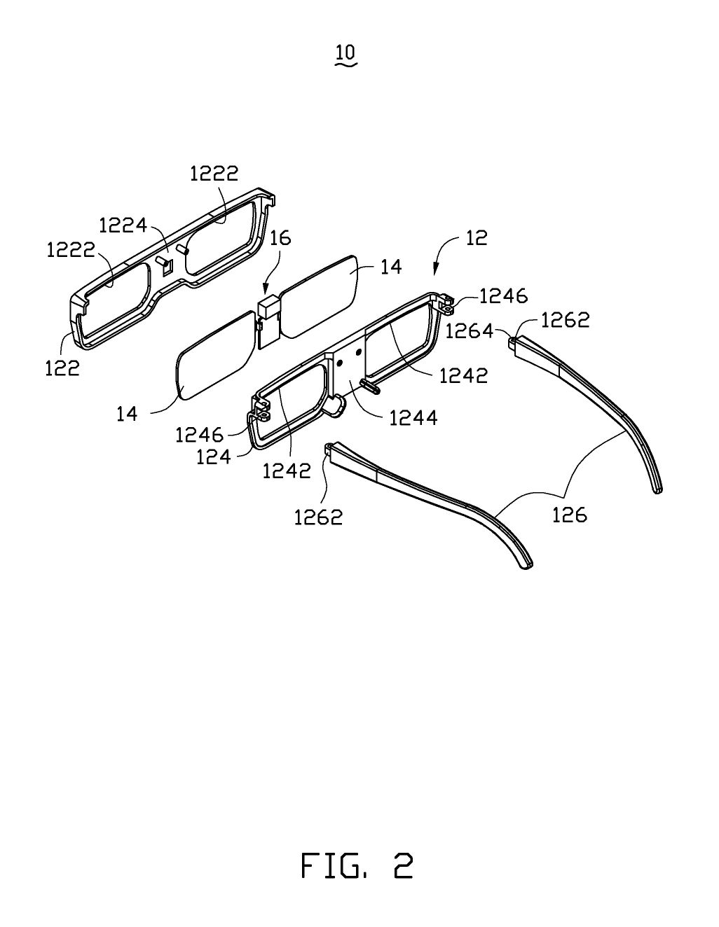

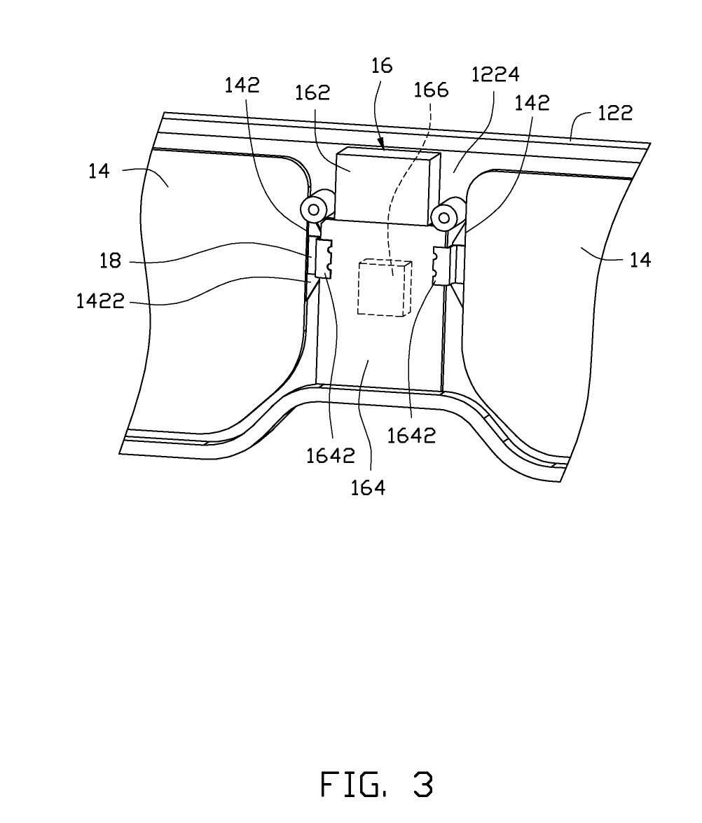

The frame 12 includes a front casing 122 and a rear casing 124. The front casing 122 has a cover 1224 and a pair of front rims 1222 symmetrical along the cover 1224 (see FIG. 2). The rear casing 124 has a recess 1244 corresponding, to the cover 1224 and a pair of rear rims 1242 symmetrical along the recess 1244. The front rims 1222 and the rear rims 1242 are engaged to define a pair of rims 123 for holding the lenses 14 and an interior space 13 (see FIG. 3) for receiving the control unit 16. The interior space 13 is enclosed by the cover 1224 and the recess 1244.

A pair of temple arms 126 are pivotally connected to the frame 12. Each temple arm 126 has a tab 1262 extends outwardly and is received in a pivot pad 1246 formed on the right or left end of the rear casing 124. A fastener such as a pm or a screw extends through an aperture 1264 defined in the tab 1262 and the pivot pad 1246, thereby pivotably securing the tab 32 within the pad 1246. The temple arms 126 hang on a viewer's ears allowing the lenses 14 to be positioned in front of the viewer's eyes.

Referring to FIG. 2 also, the control unit 16 including a battery 162, a circuit board 164, and an infrared device 166 are placed in the interior space 13. The battery 162 and the infrared device 166 are electrically connected to the circuit board 164. The battery 162 provides power to the circuit board 164, the infrared device 166, and other apparatus electrically connected to the circuit board 162. The circuit board 164 has two conductive pads 1642 positioned on opposite sides and adjacent to the lenses 14. Each lens 14 has an electrical adjoining pad 1422 at its inner edge 142, facing the circuit board 164, and electrically connected to the conductive pad 1642. Each electrical adjoining pad 1422 and the corresponding conductive pad 1642 are electrically connected through a flexible circuit board 18. Therefore, the circuit board 164 is electrically connected to the lenses 14 through the flexible circuit board 18 and alternately dim the right and then the left lenses 14 in succession so that each of the viewer's eyes sees a slightly different angle of the same image to create a 3D stereoscopic effect.

To assemble the 3D glasses 10, the lenses 14 are electrically connected to the circuit board 164. The lenses 14 are placed between the front rims 1222 and the back rims 1242, and the circuit board 164 is placed between the cover 1224 of the front casing 124 and the recess 1244 of the rear casing 124. The front casing 122 and the rear casing 124 are engaged to enclose the control unit 16 (including the circuit board 164) in the interior space 13 defined between the cover 1224 and the recess 1244. The conductive pads 1642 are placed in the interior space 13, which is located at the center of the frame 12. The front rims 1222 and the rear rims 1242 are combined to define the rims 123 on left and right for holding the lenses 14. The front casing 122 and the rear casing 124 may be engaged together with fasteners such as screws or clips. The circuit board 164 is placed in the interior space 13. Accordingly, connections of the flexible circuit boards IS used in the present embodiment cover a much shorter distance. In addition to lowering manufacturing cost, the 3D glasses 10 prevent accidental peeling of the flexible circuit board 1422 during assembly.

Therefore, the electrical components (including the lens 14 and the control unit 16) are placed in the frames 12 and the center of mass is positioned between the rims 13 of the 3D glasses 10. The 3D glasses 10 have a lighter and slimmer construction. When a viewer wears the 3D glasses 10 of the disclosure, the weight of the 3D glasses 10 is more evenly distributed which makes for as much more pleasant user experience. Thus, the 3D glasses 10 of the disclosure provides stereoscopic image, user comfort, ease of use, and lower construction cost.

Although the present disclosure has been specifically described on the basis of this exemplary embodiment, the disclosure is not to be construed as being limited thereto. Various changes or modifications may be made to the embodiment without departing from the scope and spirit of the disclosure.

What is claimed is:

1. A pair of 3D glasses, comprising:
a pair of lenses;
a frame comprising a front casing and a rear casing attached to the front casing to define:
a pair of rims for holding the lenses; and
an interior space positioned in the middle of the frame;
a control unit positioned in the interior space, comprising:
a circuit board electrically connected to the lenses; and
a battery and an infrared device mounting on the circuit board; and
a pair of temple arms pivotally connected to the frame for mounting on a viewers head.

2. The 3D glasses of claim 1, wherein the interior space is located between the rims.

3. The 3D glasses of claim 1, wherein the front casing comprises a cover configured for a recess defined in the rear casing.

4. The 3D glasses of claim 3, wherein the interior space is defined by the cover of the front casing and the recess of the rear casing.

5. The 3D glasses of claim 1, wherein the rear casing comprises two tabs positioned on right and left ends for engaging with the temple arms.

6. The 3D glasses of claim 1, wherein each lens comprising an electrical adjoining pad at its inner edge, and the electrical adjoining pad is located at the center of the frame and adjacent to the interior space.

7. The 3D glasses of claim 6, wherein the circuit board has two conductive pads positioned on opposite sides of the circuit board and are electrically connected to the electrical adjoining pads of the lenses.

8. The 3D glasses of claim 7, wherein each conductive pad and the corresponding electrical adjoining pad are connected through a flexible circuit board.

9. The 3D glasses of claim 1, wherein the battery and the infrared device are electrically connected to the circuit board.
